(19) United States
(12) Patent Application Publication
(10) Pub. No.: US 2025/0297646 A1
(43) Pub. Date: Sep. 25, 2025

(54) STRUT BEARING

(71) Applicants: AKTIEBOLAGET SKF, GOTEBORG (SE); SKF Japan Ltd., Yokohama (JP)

(72) Inventors: Takaaki IESATO, Yokosuka-shi (JP); Bruno MONTBOEUF, Saint-Cyr-Sur-Loire (FR); Jordan RENAUDON, Saint-Cyr-sur-Loire (FR); Tatsuya KANEKO, Yokohama-shi (JP)

(21) Appl. No.: 19/079,720

(22) Filed: Mar. 14, 2025

(30) Foreign Application Priority Data
Mar. 22, 2024 (JP) 2024-046564

(51) Int. Cl. F16C 35/04; F16C 19/16

(52) U.S. Cl. CPC F16C 35/04; F16C 19/16; F16C 2326/05

(57) ABSTRACT

A strut bearing is provided to reduce an overall height of a vehicle when a suspension strut is attached to the vehicle. The strut bearing includes an upper housing, a lower housing and a rolling bearing arranged between the upper and lower housings. The rolling bearing includes an inner race, an outer race and rolling elements arranged between the inner and outer races. One of the inner and outer races is attached to the upper housing and the other one of the inner and outer races is attached to the lower housing. An insert and an isolator are each attached to the lower housing. The insert has a first surface that is attached to the lower housing. The isolator is attached to a second surface of the insert with an attaching surface provided to the isolator. Thereby, at least a part of the isolator is directly attached to the insert.

### CROSS-REFERENCE

This application claims priority to Japanese patent application no. 2024-046564 filed on Mar. 22, 2024, the contents of which are fully incorporated herein by reference.

### BACKGROUND OF THE INVENTION

The present invention relates to a strut bearing, particularly a McPherson type (“McPherson Strut Bearing Unit” or MSBU), for use in a suspension strut attached to a vehicle. The field of the present invention is in suspension systems, particularly automotive suspension systems.

The automotive suspension system includes a suspension strut supporting an axle and a wheel. The strut bearing is arranged in the upper portion of the suspension strut opposite the wheels and the ground, and between the suspension spring and an upper support block attached to the vehicle chassis.

The suspension strut bearing device includes at least one bearing, such as a rolling bearing, that includes an upper housing and a lower housing that rotate relatively around a main shaft.

A strut bearing of a conventional technique is shown in FIG. 1. As shown in FIG. 1, the strut bearing 900 of the conventional technique includes an upper housing 921 and a lower housing 922. A rolling bearing 910 is provided between the upper housing 921 and the lower housing 922. The rolling bearing 910 includes an inner race (inner ring) 911 attached to the upper housing 921 and an outer race (outer ring) 912 attached to the lower housing 922. Balls serving as rolling elements 913 are arranged between the inner race 911 and the outer race 912. In addition, particularly when the rolling bearing 910 is an angular type, a cage 914 for holding the rolling elements 913 is provided.

The upper housing 921 and the lower housing 922 can rotate relatively to the damper rod 902, which serves as the main shaft, using the rolling bearing 910.

The lower housing 922 includes an insert (metal insert) 930 to increase the rigidity.

In addition, the lower housing 922 has a portion with which the spring 901 is in contact, and the portion has an isolator 940 set thereon that is made of an elastic material.

An insert 930 is integrally molded with a lower housing 922 by injection molding. For this reason, the insert 930 is embedded in the lower housing 922.

An isolator 940 is overmolded and set on the lower housing 922.

The insert 930 is provided in the lower housing 922. For this reason, when the isolator 940 is overmolded on the lower housing 922, as shown in FIG. 1, the attaching wall 923, which is a part of the lower housing 922, is interposed between the isolator 940 and the insert 930.

In recent years, the demand for a lower profile of vehicles has created a corresponding demand for reducing the bonnet heights of vehicles. When attaching a suspension strut to a vehicle, a certain width needs to be secured between the upper portion of the suspension strut and the bonnet surface of the vehicle from the standpoint of safety. As a result, the suspension strut may be an obstacle to achieving a lower profile of the vehicle.

In order to achieve a lower profile of the vehicle while securing a certain width between the upper portion of the suspension strut and the bonnet surface of the vehicle, it may be possible to simply design the height of the strut bearing to be low or have a reduced height.

However, if the height of the strut bearing is simply designed to be reduced with an otherwise conventional configuration, the injection molding material may not sufficiently penetrate to the thin-walled portion because the housing 920 used in the strut bearing is manufactured by injection molding. For this reason, it is not practical to simply design the strut bearing with a reduced heigh.

The insert of the strut bearing is necessary to ensure a sufficient strength of the housing when the vehicle weight increases, and as such, it is difficult to configure or design the strut bearing without an insert.

### SUMMARY OF THE INVENTION

The present invention provides a strut bearing that can achieve a lower profile of a vehicle while securing a certain width between an upper portion of a suspension strut and a bonnet surface of the vehicle.

According to a first aspect of the present invention, a strut bearing for use in a suspension strut of a vehicle includes an upper housing, a lower housing, and a rolling bearing arranged between the upper housing and the lower housing. The rolling bearing includes an inner race, an outer race, and rolling elements arranged between the inner race and the outer race. One of the inner race and the outer race is attached to the upper housing, and the other of the inner race and the outer race is attached to the lower housing. An insert and an isolator are attached to the lower housing. The insert has a first surface that is attached to the lower housing. The isolator is attached to a second surface of the insert with an attaching surface provided on the isolator. Thereby, at least a part of the isolator is directly attached to the insert.

The insert may include an auxiliary attaching part. A through hole may be provided in the insert and a part of the isolator that goes or extends through the through hole to be attached to the lower housing may configure the auxiliary attaching part.

A plurality of the auxiliary attaching parts may be provided to the lower housing in a circumferential direction.

The plurality of the auxiliary attaching parts may be provided to the lower housing in a circumferential direction with equal intervals.

The through hole may have a circular cross section.

The through hole may have a cross section with a polygonal shape.

According to a second aspect of the present invention, the lower housing according to the first aspect of the present invention includes a radial portion and an axial portion.

The second surface of the insert is provided only on the radial portion.

The attaching surface of the isolator is attached to the second surface that is provided to the radial portion.

According to a third aspect of the present invention, a method for manufacturing a strut bearing includes:
a first mold injection step for performing injection molding of the lower housing to the first surface of the insert; and
a second mold injection step for performing injection molding of the isolator to the second surface of the insert.

The present invention makes it possible to achieve a lower profile of the vehicle while securing a certain width between the upper portion of the suspension strut and the bonnet surface of the vehicle.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a diagram showing a strut bearing of a conventional technique;

FIG. 2 is a diagram showing a strut bearing according to a first embodiment of the present invention;

FIG. 3 is a diagram showing an auxiliary attaching part included in the strut bearing according to the first embodiment of the present invention;

FIG. 4 is a diagram showing an arrangement of auxiliary attaching parts included in the strut bearing according to the first embodiment of the present invention;

FIG. 5 is a diagram showing a strut bearing according to a second embodiment of the present invention; and

FIG. 6 is a flow chart showing a method for manufacturing the strut bearing according to the present invention.

### DETAILED DESCRIPTION OF THE INVENTION

### First Embodiment

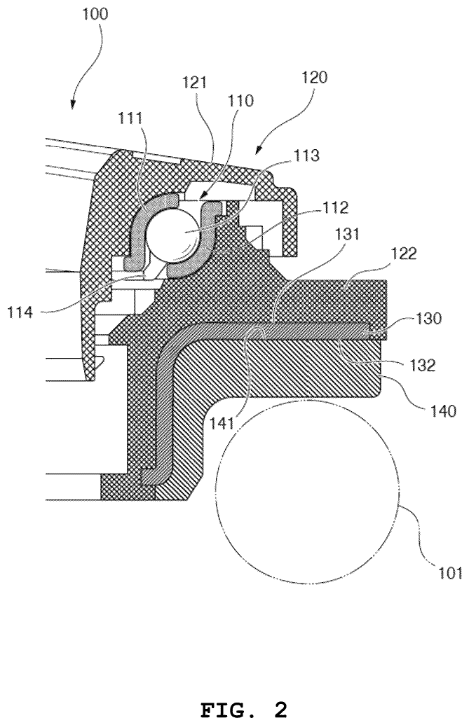

A first embodiment of the present invention will be described below with reference to FIGS. 2 to 4.

FIG. 2 shows a strut bearing 100 according to a first embodiment of the present invention. As shown in FIG. 2, the strut bearing 100 according to the invention of the present application includes an upper housing 121 and a lower housing 122. A rolling bearing 110 is provided between the upper housing 121 and the lower housing 122.

The upper housing 121 and the lower housing 122 are preferably made of a hard plastic material or other suitable polymeric material.

The rolling bearing 110 is composed of an inner race (or “inner ring”) 112, an outer race (or “outer ring”) 111, and rolling elements 113, which are preferably balls, arranged between the outer race 111 and the inner race 112. In the illustrated example, the inner race 112 is attached to the upper housing 121 and the outer race 111 is attached to the lower housing 122. However, the present invention is not limited to this particular configuration. For example, a configuration may be provided such that the outer race 111 is attached to the upper housing 121 and the inner race 112 is attached to the lower housing 122. In addition, the rolling bearing 110 according to this embodiment is an angular contact type, such that a cage 114 for holding the rolling elements 113 is preferably provided.

The upper housing 121 and the lower housing 122 are capable of relative rotation around the main shaft by the rolling bearing 110.

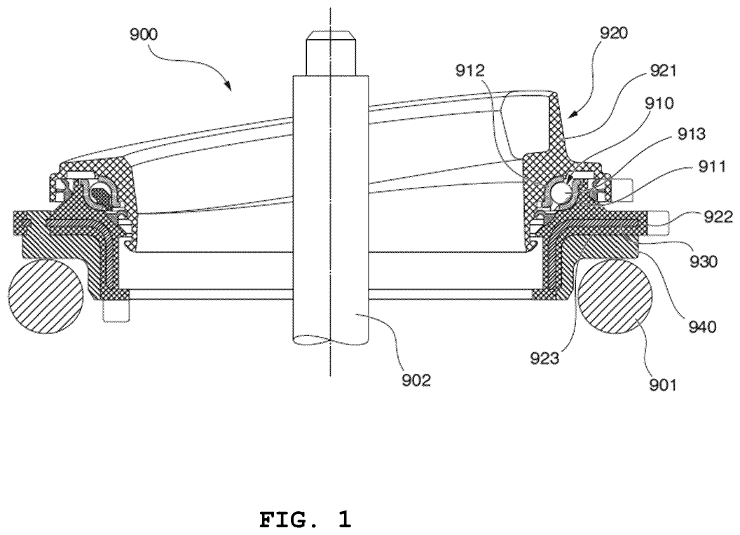

The lower housing 122 includes an insert 130, preferably a metal insert, to increase rigidity. In the present embodiment as shown in FIG. 1, the insert 130 is preferably not embedded in the lower housing 122.

Specifically, the insert 130 includes a first surface 131 and a second surface 132. In this embodiment, the insert 130 has a first surface 131 attached to the surface of an attaching wall 123 of the lower housing 122.

Furthermore, the lower housing 122 has a portion which is contacted by a spring 101 and the portion has an isolator 140 set or disposed thereon, the isolator 140 preferably being made of an elastic material.

The isolator 140 includes a rubber-like thermoplastic elastomer (“TPE”), preferably a thermoplastic polyurethane (“TPU”), a melt-processable elastomer (“MPE”), or an elastomer cell foam.

The isolator 140 of this embodiment has an attaching surface 141 attached to the second surface 132 of the insert 130 and is not attached to the lower housing 122.

Furthermore, in the strut bearing 100 according to this embodiment, at least one and preferably a plurality of auxiliary attaching parts 142 are preferably provided between the isolator 140 and the lower housing 122.

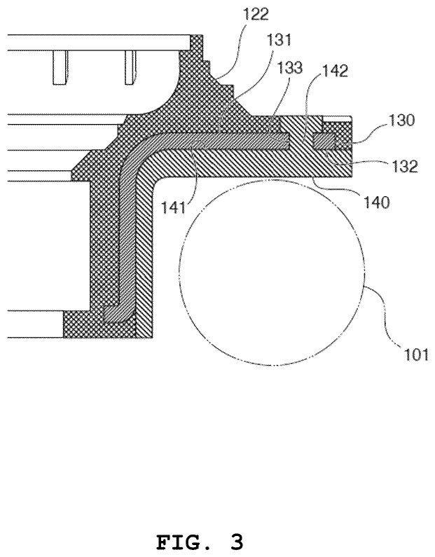

The configuration or preferred structure of each auxiliary attaching part 142 is shown in FIG. 3. When the auxiliary attaching part(s) 142 is/are provided, a through hole 133 is provided in the insert 130. When the isolator 140 is injection molded to the insert 130, a part or portion of the isolator 140 passes or flows through the through hole 133 and is directly attached to the lower housing 122.

Thus, the part of the isolator 140 that passes or extends through the through hole 133 and is directly attached to the lower housing 122 forms the auxiliary attaching part 142.

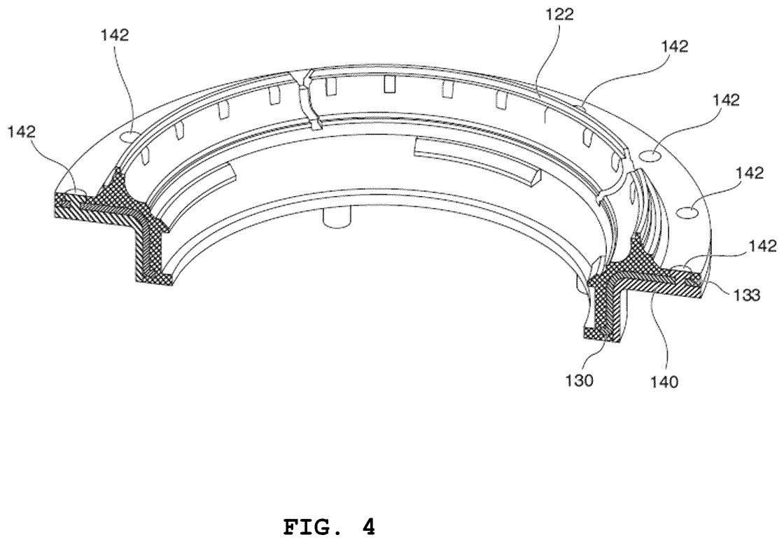

As shown in FIG. 4, the auxiliary attaching part 142 is arranged or disposed in the circumferential direction of the lower housing 122. In other words, the plurality of auxiliary attaching parts 142 are spaced circumferentially apart about the lower housing 122. In this embodiment, the intervals between adjacent auxiliary attaching parts 142 are equal or even. However, the intervals between adjacent auxiliary attaching parts 142 may be unequal; i.e., the parts 142 may be unevenly spaced apart or “staggered”.

In addition, the through hole 133 depicted in FIG. 4 preferably has a circular cross section. However, the shape of the through hole 133 is not limited to being circular and may have a circumferential outer perimeter of any appropriate shape, for example, a polygonal-shaped through hole 133 may be provided.

By providing the auxiliary attaching parts 142, it is possible to prevent relative rotation between the insert 130 and the isolator 140. As such, it is possible to maintain the reliability of the strut bearing even if the isolator 140 is attached directly to the metal insert attached to the surface of the lower housing 122, rather than being overmolded onto the lower housing 122.

As described above, in this embodiment, the first surface 131 of the insert 130 is attached to the surface of the attaching wall 123 of the lower housing 122, and the attaching surface 141 of the isolator 140 is attached to the second surface 132 of the insert 130. Thereby, the isolator 140 is directly attached to the insert 130.

Furthermore, by providing the auxiliary attaching parts 142, it is possible to prevent relative rotation between the insert 130 and the isolator 140.

The above-described configuration or design makes it possible to eliminate the attaching wall that is interposed or disposed between the isolator and the insert in a conventional design without compromising the reliability of the strut bearing 100, and makes it possible to reduce the overall height of the strut bearing 100. Further, the design of the present strut bearing 100 makes it possible to achieve a lower profile of the vehicle while securing a certain width between the upper portion of the suspension strut and the bonnet surface of the vehicle.

### Second Embodiment

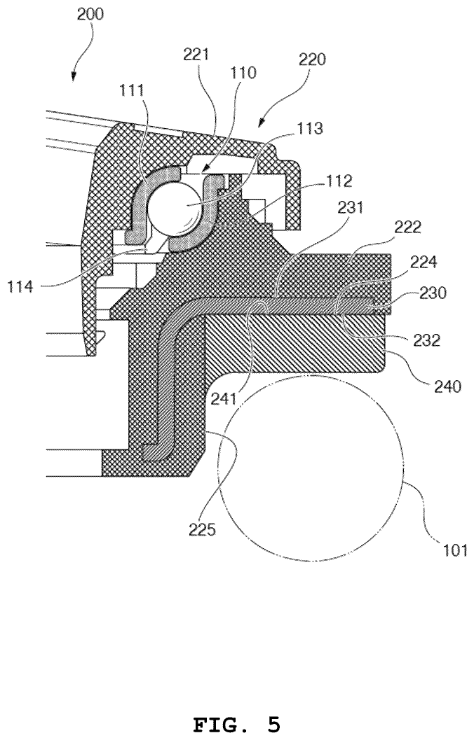

A second embodiment of the present invention is shown in FIG. 5.

Note that, in the second embodiment as described below, components common to those of the first embodiment shown in FIGS. 2-4 are designated with the same reference numerals and characters and their description will be omitted below.

In the strut bearing 100 of the first embodiment, the entire surface of one side of the insert 130 forms the first surface 131, which is attached to the lower housing 122. Therefore, the entire surface of the other side of the insert 130 forms the second surface 132, and the second surface 132 is attached to the attaching surface 141 of the isolator 140.

However, in a strut bearing 200 according to the second embodiment, only a part of one surface of the insert 130 forms the first surface 231, rather than the entire surface thereof.

As shown in FIG. 5, the strut bearing 200 of the second embodiment includes a lower housing 222. The lower housing 222 includes a radial portion 224 and an axial portion 225.

As shown in FIG. 5, a part of the insert (e.g., a metal insert) 230 according to the second embodiment is embedded in the axial portion 225. A part of the insert 230 along the radial portion 224 has a first surface 231 attached to the surface of the lower housing 222.

As shown in FIG. 5, the surface of the insert 230 opposite to the first surface 231 forms a second surface 232 that is the attaching surface for an isolator 240.

The isolator 240 has a attaching surface 241 attached to the second surface 232 of the insert 230.

Therefore, in the strut bearing 200 according to the second embodiment, there is an attaching wall in the radial direction as in the conventional technique, but there is no attaching wall in the axial direction, and the isolator 240 is directly attached to the insert 230.

Even with this configuration, the attaching wall can be eliminated that has been conventionally present in the height direction of the strut bearing 200. Therefore, as in the first embodiment, this structure or arrangement makes it possible to achieve a lower or reduced profile of the vehicle while securing or maintaining a certain width between the upper portion of the suspension strut and the bonnet surface of the vehicle.

### Manufacturing Method

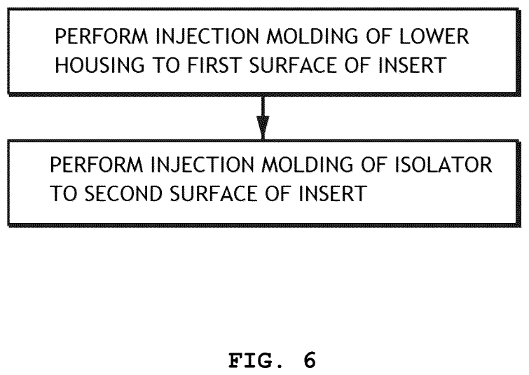

A manufacturing method of the strut bearing according to the present invention is shown in FIG. 6.

In conventional strut bearings, the metal insert is embedded in the lower housing. In other words, the strut bearing has been manufactured in such a way that injection molding forms the lower housing made of a hard plastic around a metal insert, and then overmolding forms the isolator onto the lower housing.

In the strut bearing of the invention of the present application, the isolator is attached directly to the insert.

For this reason, as shown in step S1 in FIG. 6, a first mold injection step is first performed for injection molding of the lower housing onto the insert.

After the first mold injection step is completed, a second mold injection step is performed for injection molding of the isolator onto the insert, as shown in S2.

Performing the above steps enables the realization of a configuration or design in which an insert is attached to the surface of the lower housing and an isolator is directly attached to this insert.

The strut bearing of the present invention makes it possible to keep the overall height of the vehicle low when a strut suspension is attached to a vehicle using the strut bearing. In other words, the structure of the present strut bearing enables a reduction in the overall height of the vehicle when the strut suspension is attached to the vehicle by means of the present strut bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE SIGNS LIST

100, 200 strut bearing
101 spring
110 rolling bearing
111 outer race (outer ring)
112 inner race (inner ring)
113 rolling element (ball)
114 cage
121, 221 upper housing
122, 222 lower housing
130, 230 insert (metal insert)
131, 231 first surface
132, 232 second surface
133 through hole
140, 240 isolator
141, 241 attaching surface
142 auxiliary attaching part
224 radial portion
225 axial portion

We claim:

1. A strut bearing for use in a suspension strut of a vehicle, the strut bearing comprising:
an upper housing;
a lower housing including an insert and an isolator, the insert having a first surface and a second surface and being attached to the lower housing with the first surface, the isolator being attached to the second surface of the insert with an attaching surface provided on the isolator such that at least a part of the isolator is directly attached to the insert; and
a rolling bearing arranged between the upper housing and the lower housing and including an outer race, an inner race and rolling elements arranged between the outer race and the inner race;
wherein one of the outer race and the inner race is attached to the upper housing, and another one of the outer race and the inner race is attached to the lower housing;

2. The strut bearing according to claim 1, wherein the insert is provided with an auxiliary attaching part.

3. The strut bearing according to claim 2, wherein a through hole is provided in the insert and a part of the isolator extends through the through hole and is attached to the lower housing so as to provide the auxiliary attaching part.

4. The strut bearing according to claim 2, wherein a plurality of the auxiliary attaching parts are provided on the lower housing in a circumferential direction.

5. The strut bearing according to claim 4, wherein the plurality of the auxiliary attaching parts are circumferentially spaced apart in equal intervals.

6. The strut bearing according to claim 3, wherein the through hole has a circular cross section.

7. The strut bearing according to claim 3, wherein the through hole has a cross section with a polygonal shape.

8. The strut bearing according to claim 1, wherein:
the lower housing includes a radial portion and an axial portion;
the second surface of the insert is provided only on the radial portion; and
the attaching surface of the isolator is attached to the second surface that is provided on the radial portion.

9. A method for manufacturing the strut bearing according to claim 1, the method comprising the steps of:
a first mold injection step for injection molding of the lower housing to the first surface of the insert; and
a second mold injection step for performing injection molding of the isolator to the second surface of the insert.
